(19) United States
(12) Patent Application Publication
(10) Pub. No.: US 2023/0024443 A1
(43) Pub. Date: Jan. 26, 2023

(54) EVAPORATION WATER TANK FOR A FUEL CELL DEVICE AND THE USE THEREOF IN A FUEL CELL DEVICE

(71) Applicant: Mahle International GmbH, Stuttgart (DE)

(72) Inventors: Michael Baumann, Ammerbuch (DE); Richard Bruemmer, Stuttgart (DE); Matthias Gaenswein, Esslingen (DE); Sven Alexander Kaiser, Waiblingen (DE); Frank Von Luetzau, Winnenden (DE); Jan Schultes, Stuttgart (DE); Thomas Strauss, Notzingen (DE)

(21) Appl. No.: 17/869,782

(22) Filed: Jul. 20, 2022

(30) Foreign Application Priority Data
Jul. 21, 2021 (DE) 10 2021 207 808.7

(51) Int. Cl. H01M 8/04119; H01M 8/04007; H01M 8/04828

(52) U.S. Cl. CPC H01M 8/04126; H01M 8/04007; H01M 8/04828; H01M 2250/20

(57) ABSTRACT

An evaporation water tank for a fuel cell device may include a tank bottom, a plurality of tank side walls, and a tank cover that collectively define a collection volume for evaporation water and tank air. The plurality of tank side walls may be arranged on and project away from the tank bottom. The tank cover may be arranged a distance away from the tank bottom and on the plurality of tank side walls. The tank may also include an evaporation water inlet via which an inflow of evaporation water is flowable into the collection volume and at least one evaporation water outlet via which an outflow of evaporation water is flowable from the collection volume. The evaporation water inlet may be arranged on at least one of the plurality of tank side walls. The at least one evaporation water outlet may be arranged on the tank bottom.

### CROSS-REFERENCE TO RELATED APPLICATIONS

This application claims priority to German Patent Application No. DE 10 2021 207 808.7, filed Jul. 21, 2021, the contents of which is hereby incorporated by reference in its entirety.

### TECHNICAL FIELD

The invention relates to an evaporation water tank for a fuel cell device and the use thereof in a fuel cell device.

### BACKGROUND

Evaporation water tanks of the type mentioned have been known for a long time. The disadvantage of these tanks is that the production thereof is relatively expensive.

### SUMMARY

The object of the invention is to specify an improved or at least a different embodiment for an evaporation water tank for a fuel cell device.

This object is achieved with the present invention particularly by means of the subject matter of the independent claims. Advantageous embodiments are the subject matter of the dependent claims.

The basic idea of the invention is to specify an evaporation water tank for a fuel cell device that can be manufactured at low cost.

For this purpose, according to the invention, an evaporation water tank is provided for a fuel cell device, in particular for a fuel cell device integrated into a motor vehicle, which has a collection volume for evaporation water and tank air. This collection volume is delimited or formed by a tank bottom of the evaporation water tank, by several tank side walls of the evaporation water tank, which are each arranged integrally on the tank bottom and projecting away therefrom, and by a tank cover of the evaporation water tank, which tank cover is arranged at a distance of several millimeters or centimeters or decimeters from the tank bottom and integrally on the tank side walls. The evaporation water tank according to the invention also has an evaporation water inlet, arranged on at least one tank side wall of these tank side walls or on the tank cover, for the inflow of evaporation water into the evaporation water tank. In practice, tank air can also get into the evaporation water tank through the evaporation water inlet. This tank air, for example, can be carried along by the evaporation water in dissolved or undissolved form. The evaporation water tank according to the invention also has exactly one or at least one evaporation water outlet arranged on the tank bottom for the outflow of evaporation water from the evaporation water tank. Evaporation water inlets and/or evaporation water outlets can be regulated or controlled. This advantageously specifies an evaporation water tank for a fuel cell device, which evaporation water tank can be manufactured at low cost.

Furthermore, exactly two separate evaporation water outlets can be arranged on the tank bottom of the evaporation water tank, which evaporation water outlets are each used for the outflow of evaporation water from the evaporation water tank. It can expediently be provided in this case that the evaporation water tank has a tank central axis perpendicular to the tank bottom, wherein the two separate evaporation water outlets are spaced apart from one another in a transverse direction, oriented transversely with respect to the tank central axis, particularly at right angles. In particular, the evaporation water outlets can be arranged at a lowest point of the evaporation water tank, wherein this lowest point is expediently arranged protruding over the tank side walls in the direction of the tank central axis, particularly downwards.

It can further expediently be provided that a first evaporation water outlet of the two separate evaporation water outlets forms or opens into a sprinkler valve for controlling or regulating the mass or volume flow of the evaporation water flowing out of the evaporation water tank. Alternatively, it can be provided that a first evaporation water outlet of the two separate evaporation water outlets forms or opens into a conveying device for conveying evaporation water out of the evaporation water tank. Alternatively or additionally, it can be provided that a second evaporation water outlet of the two separate evaporation water outlets forms or opens into a water outlet valve for draining evaporation water from the evaporation water tank. As a result, the evaporation water flowing out of the evaporation water tank can be controlled using relatively inexpensive means.

The evaporation water tank can expediently have a tank central axis which is perpendicular to the tank bottom, wherein at least one tank side wall of these tank side walls is arranged at an angle with respect to the tank central axis. Alternatively, at least two tank side walls can be arranged at an angle with respect to the tank central axis. In particular, provision can be made for these at least two tank side walls to taper towards the tank bottom. This ensures that the at least one evaporation water outlet arranged on the tank bottom is always exposed to evaporation water, i.e. is arranged below the evaporation water level, even if there is a fluctuating movement of the evaporation water in the evaporation water tank, which occurs, for example, when the evaporation water tank is installed in a motor vehicle and the vehicle is moved. Furthermore, the evaporation water tank can have a tank central axis which is perpendicular to the tank bottom, wherein at least two tank side walls of these tank side walls are opposite with respect to the tank central axis in a transverse direction oriented transversely, particularly at a right angle, as relates to the central axis, each spanning a tank side wall angle between itself and the tank central axis in the range from greater than or equal to 5° to less than or equal to 15°. In principle, also conceivable are other tank side wall angles, for example tank side wall angles in the range from greater than 15° to less than or equal to 45° or greater than 45° to less than 90° can be useful. For example, the pressure stability or, in general, the mechanical load-bearing capacity of the evaporation water tank can be optimized by means of tank side walls that extend obliquely with respect to the tank central axis. Furthermore, tank side walls that extend obliquely with respect to the tank central axis can prevent the evaporation water tank from bursting when the evaporation water freezes in that the freezing evaporation water can escape in the direction of the tank central axis, towards the tank cover, i.e. particularly upwards. In other words, the resulting block of ice can escape from the evaporation water.

Further expediently, the evaporation water inlet can be arranged on a single tank side wall of these tank side walls, below or above or at the same level as an expected evaporation water level. The evaporation water level expediently characterizes a plane which delimits the evaporation water arranged in the evaporation water tank from the tank air also located there. As a result, a backflow of evaporation water into components of the fuel cell device arranged upstream of the evaporation water tank can be prevented, for example into a cathode exhaust air flow of a fuel cell of a fuel cell device. This has the advantage that, for example, a non-return valve on the evaporation water inlet can be dispensed with, as a result of which the evaporation water tank can be provided relatively inexpensively.

The evaporation water tank can expediently have a ventilation opening, through which tank air from the evaporation water tank can pass, for venting the evaporation water tank. The ventilation opening can be arranged, for example, in a tank section of the evaporation water tank above the expected evaporation water level. It is at least conceivable that such a tank section is formed by a section of a tank side wall. Furthermore, it is conceivable that such a tank section is formed by a section or the entire tank cover. The ventilation opening makes it possible for the evaporation water tank to be kept pressureless, for example when a conveying device for conveying evaporation water from the evaporation water tank is connected to same.

Further expediently, the ventilation opening can be covered by a membrane through which tank air from the evaporation water tank can pass. For this purpose, the membrane can be permeable to tank air or assigned to the ventilation opening in a movable manner and can be moved back and forth between a closed position blocking the ventilation opening for tank air and at least one open position releasing the ventilation opening for tank air. Furthermore, it can be advantageous if the membrane is impermeable to water, so that evaporation water cannot accidentally escape from the evaporation water tank through the ventilation opening. As a result, the ingress of foreign substances such as dirt particles through the ventilation opening into the evaporation water tank can advantageously be suppressed, as a result of which contamination of the evaporation water is prevented.

Tank air in terms of the invention is expediently the ambient air of the evaporation water tank, i.e. in particular air which mainly contains nitrogen and oxygen and also has traces of other gases. Tank air in terms of the invention, however, can also be exhaust air from a cathode exhaust air flow flowing out of a fuel cell or supply air from a cathode supply air flow supplied to the fuel cell. It is also possible for tank air in terms of the invention to be a mixture formed from this exhaust air and this supply air and/or this ambient air.

Expediently, the tank side walls can each have a large inner tank surface oriented toward the collection volume that is covered or at least can be covered with evaporation water and tank air, wherein a biocidal and/or algae-growth-inhibiting and/or antibacterial coating is arranged on at least one of these large inner tank surfaces. Such a coating can be used to efficiently prevent, in particular, the growth of algae and/or bacteria in the evaporation water. It is at least conceivable that the coating is made entirely or at least partially of zinc pyrite. Of course, it can also contain other algae-growth-inhibiting and/or antibacterial substances.

The tank volume, which is also referred to as the collection volume, is expediently designed in such a way that a maximum of 91% of the tank volume can be used. This means that the tank volume of the tank can be filled with evaporation water up to a maximum of 91%. The remaining tank volume of at least 9%, particularly 8.91%, is reserved for the volume expansion of the evaporation water in the event that the evaporation water freezes.

More expediently, a respective coating can cover at least 20% of the respective large internal tank surfaces. Additionally or alternatively, it is conceivable that a respective coating covers a maximum of 90% or 95% of the respective large inner tank surfaces. In practice, however, it can be provided that a respective coating covers the respective large inner tank surfaces over the entire surface thereof. As a result, algae and/or bacterial growth in the evaporation water can be efficiently prevented.

At least one tank side wall of these tank side walls can expediently have a biocidal and/or algae-growth-inhibiting and/or antibacterial substance which interacts with the evaporation water collected in the evaporation water tank. It can be provided that biocidal and/or algae-growth-inhibiting and/or antibacterial substances are continuously released into the evaporation water, whereby, in particular, the growth of algae and/or bacteria in the evaporation water is prevented. It is at least conceivable that said substances are mixed with a tank side wall material from which the tank side walls are produced, e.g. plastic or a composite. This has the particular advantage that the biocidal and/or algae-growth-inhibiting and/or antibacterial substances are integrated into the tank side walls, so to speak.

Further expediently, the biocidal and/or algae-growth-inhibiting and/or antibacterial substance can be formed from zinc pyrite. In addition to zinc pyrite, other biocidal and/or algae-growth-inhibiting and/or antibacterial substances are also conceivable. In principle, there is the option of forming said substance with more than one substance, for example with a mixture of two or more antibacterial substances. It is at least conceivable that the biocidal and/or algae-growth-inhibiting and/or antibacterial effect can be achieved by UV irradiation of the evaporation water, i.e. with ultraviolet radiation with wavelengths in the range from 380 to 100 nm, and/or by an evaporation water tank made of copper.

The evaporation water tank can expediently have a compressed air inlet for compressed air to flow into the evaporation water tank. It is conceivable that a compressed air line conveying compressed air can be connected to the compressed air inlet in order for compressed air to flow into the evaporation water tank via the compressed air inlet. The compressed air in this case expediently forms tank air. This makes it possible to apply pressure to the evaporation water collected in the evaporation water tank.

Furthermore, the evaporation water tank can be designed to withstand an internal tank pressure from greater than or equal to 1.5 bar absolute pressure to less than or equal to 3.0 bar absolute pressure without being damaged. As a result, the evaporation water tank can be used in a relatively large pressure window, so that it can be used in fuel cell devices, for example.

Furthermore, it is expediently provided that the collection volume of the evaporation water tank is from greater than 0 liters/kW to 0.1 liters/kW of installed electrical power of a fuel cell of the fuel cell device.

The evaporation water tank can expediently have a measuring tap for arranging a sensor, in particular a pressure sensor. If the sensor is implemented as a pressure sensor, it can be expedient to arrange the measuring tap on the tank cover above the expected evaporation water level or on at least one tank side wall, so that the pressure of the tank air in the evaporation water tank can always be measured. This makes it possible to monitor the evaporation water tank with relatively cheap and simple means.

According to another basic idea of the invention, which can be implemented in addition or as an alternative to the basic idea mentioned above, use of an evaporation water tank according to the invention is provided in a fuel cell device according to the previous description. A corresponding fuel cell device or a corresponding evaporation water tank can be integrated or retrofitted into a motor vehicle.

The fuel cell device can expediently have a fuel cell, a supply air path leading to the fuel cell for a cathode supply air flow of water-containing supply air supplied to the fuel cell, and an exhaust air path leading away from the fuel cell for a cathode exhaust air flow of a water-containing exhaust air flowing out of the fuel cell. In this case, the supply air path and the exhaust air path are routed through a humidifier of the fuel cell device that communicates fluidically with the supply air and the exhaust air for humidifying the supply air and dehumidifying the exhaust air. Furthermore, the exhaust air path is routed through a water separator of the fuel cell device, which water separator communicates fluidically with the exhaust air for removing fine and/or coarse water from the exhaust air and for providing this water as evaporation water. Furthermore, it is provided that the fuel cell device has a heat exchanger for cooling the fuel cell, which, in turn, has an evaporative cooler for cooling the heat exchanger. The evaporative cooler is assigned to the water separator, in a manner in which there is fluidic communication, and is supplied with evaporation water by same. The evaporation water tank according to the invention is fluidically connected between the evaporative cooler and the water separator. As a result, a certain quantity of evaporation water or a certain volume of evaporation water can be stored for supplying the evaporative cooler.

Further expediently, the evaporation water tank can be assigned an intermediate wall which divides the collection volume for evaporation water into a first pressure chamber and a second pressure chamber. The evaporation water inlet for the inflow of evaporation water, which is particularly provided by a pre-separator, opens into the first pressure chamber, so that evaporation water flows or can flow through the evaporation water inlet into the first pressure chamber. A further evaporation water inlet for the inflow of evaporation water, which is particularly provided by a fine separator, opens into the second pressure chamber, so that evaporation water flows or can flow through the further evaporation water inlet into the second pressure chamber. The first pressure chamber and the second pressure chamber are connected to one another in fluidic communication in such a way that an evaporation water level can be set in the first pressure chamber which differs from an evaporation water level in the second pressure chamber, or vice versa. This equalizes a pressure difference between the first pressure chamber and the second pressure chamber, which stems, for example, from different pressure conditions in the pre-separator and in the fine separator.

Expediently, said intermediate wall may have a communication opening through which the first pressure chamber and the second pressure chamber can communicate fluidically. The communication opening expediently penetrates the intermediate wall completely. Further expediently, the communication opening is arranged in the region of the tank bottom of the evaporation water tank or at least on the intermediate wall on the tank bottom side, so that said communication opening is always immersed in evaporation water.

In summary, the following can be stated: The present invention preferably relates to an evaporation water tank for a fuel cell device, which evaporation water tank has a collection volume for evaporation water and tank air, which evaporation water tank is delimited or formed by a tank bottom, by several tank side walls arranged on the tank bottom and projecting away therefrom, and by a tank cover arranged at a distance from the tank bottom and on the tank side walls. The evaporation water tank also has an evaporation water inlet arranged on at least one tank side wall of these tank side walls for the inflow of evaporation water into the evaporation water tank and at least one evaporation water outlet arranged on the tank bottom for the outflow of evaporation water from the evaporation water tank. The present invention also preferably relates to the use of such an evaporation water tank in a fuel cell device.

Further important features and advantages of the invention will be apparent from the dependent claims, from the drawings, and from the corresponding description of the figures based on the drawings.

It is understood that the features mentioned above and those to be explained below may be used not only in the combination indicated in each case, but also in other combinations or separately, without deviating from the scope of the present invention.

Preferred exemplary embodiments of the invention are shown in the drawings and will be explained in more detail in the description below, wherein identical reference numerals denote identical or similar or functionally identical components.

### BRIEF DESCRIPTION OF THE DRAWINGS

The following is shown, schematically in each case:

FIG. 1 shows a preferred exemplary embodiment of an evaporation water tank in a sectional view;

FIG. 2 shows a diagram of a further preferred exemplary embodiment of an evaporation water tank used in a fuel cell device.

### DETAILED DESCRIPTION

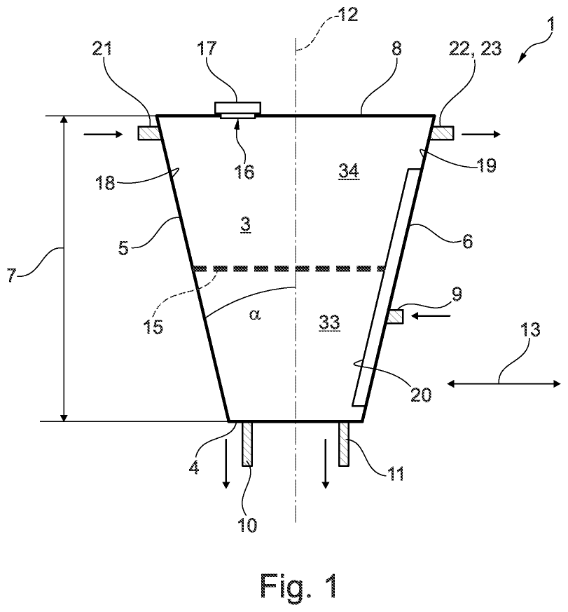

FIG. 1 shows a preferred exemplary embodiment of an evaporation water tank, which is designated overall by the reference numeral 1 and which has a collection volume 3 for evaporation water 33 and tank air 34. The collection volume 3, which can also be referred to as the tank volume, is delimited or formed by a flat tank bottom 4, by several flat tank side walls 5, 6 which are respectively arranged on the tank bottom 4 and project away therefrom, and a tank cover 8 arranged a distance 7 away from the tank bottom 4 and on the tank side walls 5, 6. The evaporation water tank 1 also has a single evaporation water inlet 9 arranged on one tank side wall 6 of these tank side walls 5, 6 for the inflow of evaporation water 33 into the evaporation water tank 1 and two separate evaporation water outlets 10, 11 arranged on the tank bottom 4 for the outflow of evaporation water 33 from the evaporation water tank 1. This makes it possible to introduce evaporation water 33 and optionally tank air 34 through the evaporation water inlet 9 into the evaporation water tank 1 for the resupply thereof. By means of the two evaporation water outlets 10, 11, evaporation water 33 can flow out of the evaporation water tank 1 in a controlled or regulated manner. It should also be mentioned that the evaporation water inlet 9 is arranged, for example, below an expected evaporation water level 15, which is indicated by a dashed line. The evaporation water level 15 designates a plane which separates the evaporation water 33 arranged in the evaporation water tank 1 from the tank air 34 also located there.

The evaporation water tank 1 also has a tank central axis 12 which is perpendicular to the tank bottom 4 and which, for example, bisects the evaporation water tank 1 in the middle. In this case, the two separate evaporation water outlets 10, 11 and the two tank side walls 5, 6 are arranged on the tank bottom 4 in such a way that they are spaced apart from one another in a transverse direction 13 oriented at right angles to the tank central axis 12. Furthermore, the two tank side walls 5, 6 are arranged obliquely with respect to the tank central axis 12 such that a tank side wall angle α of 13°, for example, is spanned between a tank side wall 5, 6 and the tank central axis 12.

The evaporation water tank 1 has a ventilation opening 16, further above the expected evaporation water level 15, through which tank air 34 can pass for venting the evaporation water tank 1. In the present case, the ventilation opening 16 is covered by a membrane 17 which can be moved back and forth between a closed position blocking the ventilation opening 16 for tank air 34, which is indicated in FIG. 1, and at least one open position releasing the ventilation opening 16 for tank air. The membrane can be used, for example, to prevent the ingress of dirt particles into the evaporation water tank 1 through the ventilation opening 16.

FIG. 1 also shows that the two tank side walls 5, 6 each have a large inner tank surface 18, 19 oriented towards the collection volume 3 and covered with evaporation water 33 and tank air 34. A biocidal and/or algae-growth-inhibiting and/or antibacterial coating 20 is arranged on the large inner tank surface 19 of the one tank side wall 6 of these tank side walls 5, 6, which coating, for example, covers about 80% of the large inner tank surfaces 19. The other tank side wall 5 of these tank side walls 5, 6 is not equipped with such a coating 20, although this is nevertheless possible.

The evaporation water tank 1 illustrated in FIG. 1 also has, for example, a compressed air inlet 21 by means of which compressed air can be fed into the evaporation water tank 1 in order to pressurize the evaporation water 33. The supplied compressed air expediently forms tank air 34. In order to monitor and possibly influence the internal pressure set in the evaporation water tank 1, the evaporation water tank 1 according to FIG. 1 has a device, characterized as a measuring tap 22, which device enables the arrangement of a sensor 23. In the present case, it is, for all practical purposes, a pressure sensor.

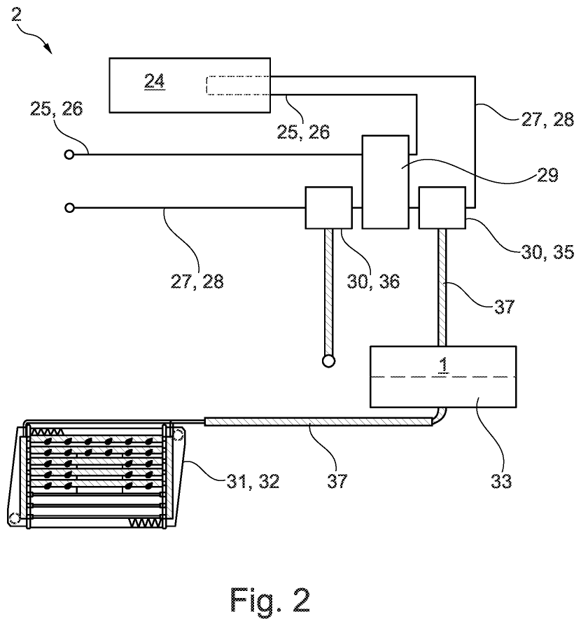

FIG. 2 shows a further preferred exemplary embodiment of an evaporation water tank 1 used in a fuel cell device 2 in a diagram. The fuel cell device 2 has a fuel cell 24 which is indicated by a simple small box. Leading to the fuel cell 24 is a supply air path 25 for a cathode supply air flow 26 of supply air supplied to the fuel cell 24, which supply air contains water. The fuel cell device 2 also has an exhaust air path 27, leading away from the fuel cell 24, for a cathode exhaust air flow 28 from exhaust air flowing out of the fuel cell 24, which exhaust air contains water. Operationally, the exhaust air flowing out of the fuel cell 24 is under an absolute pressure of, for example, 0.8 to 1.5 bar or 1.8 bar to 2.5 bar or 1.5 bar to 3.0 bar. The supply air path 25 and the exhaust air path 27 are routed together through a humidifier 29 of the fuel cell device 2, which humidifier communicates fluidically with the supply air and the exhaust air, and which is also indicated by a small box and is used to humidify the supply air and dehumidify the exhaust air. Furthermore, the exhaust air path 27 is routed through a multi-part water separator 30 of the fuel cell device 2, which water separator communicates fluidically with the exhaust air for removing water from the exhaust air and for providing this water as evaporation water 33. The part of the water separator 30 arranged in the cathode exhaust air flow 28 in the direction of the fuel cell 24, upstream of the humidifier 29, is formed, for example, by a coarse water separator 35 for removing water from the exhaust air and for providing this water as evaporation water 33. The coarse water separator 35 can remove relatively large water droplets from the exhaust air, as a result of which a relatively large quantity of water or a relatively large volume of water is advantageously obtained and made available as evaporation water 33. The other part of the water separator 30, which is arranged downstream of the humidifier 29 in the direction away from the fuel cell 24, is formed, for example, by a fine water separator 36 for removing water from the exhaust air that flows out of the humidifier 29 and for providing this water as evaporation water 33. The fine water separator 36 can remove relatively small water particles and/or residual moisture from the exhaust air. As a result, this fine water separator can advantageously remove at least a relatively small quantity of water or a relatively small volume of water from the exhaust air and make it available as evaporation water 33. The fine water separator 36 offers the further advantage that the exhaust air is dehumidified in such a way that further downstream, downstream of the water separator 30, components of the fuel cell device 2 arranged in the cathode exhaust air flow 28, in particular a compressor device not explained in detail, are protected from moisture damage, in particular from the impact of droplets. FIG. 2 also shows a heat exchanger 31 which is used to cool the fuel cell 24 and has an evaporative cooler 32 which is provided for cooling the heat exchanger 31.

In the present example, the evaporative cooler 32 is assigned to the coarse water separator 35 in a fluidically communicating manner and supplied by same with evaporation water 33. The evaporation water 33 flows, for example, through an evaporation water line 37 which fluidically connects the evaporative cooler 32 to the coarse water separator 35, into which evaporation water line the evaporation water tank 1 is fluidically integrated. This makes it possible for water to be removed from the cathode exhaust air flow 28 during operation of the fuel cell device 2 by means of the coarse water separator 35 and made available as evaporation water 33, wherein this evaporation water 33 flows into the evaporation water tank 1 and is stored there in order to continuously supply the evaporative cooler 32 with a sufficient quantity of water or a sufficient water volume of evaporation water 33 for cooling the heat exchanger 31.

1. An evaporation water tank (1) for a fuel cell device (2), particularly for a fuel cell device (2) integrated into a motor vehicle,
which has a collection volume (3) for evaporation water (33) and tank air (34), which collection volume is delimited or formed by a tank bottom (4), several tank side walls (5, 6) which are respectively arranged on the tank bottom (4) and projecting away therefrom, and a tank cover (8) arranged a distance (7) away from the tank bottom (4) and on the tank side walls (5, 6),
with an evaporation water inlet (9), arranged on at least one tank side wall (5, 6) of these tank side walls (5, 6), for the inflow of evaporation water (33) into the evaporation water tank (1),
with at least one evaporation water outlet (10, 11), arranged on the tank bottom (4), for the outflow of evaporation water (33) from the evaporation water tank (1).

2. The evaporation water tank (1) according to claim 1, characterized in that
exactly two separate evaporation water outlets (10, 11) are arranged on the tank bottom (4) of the evaporation water tank (1) for the outflow of evaporation water (33) from the evaporation water tank (1).

3. The evaporation water tank (1) according to claim 1 or 2, characterized in that
the evaporation water tank (1) has a tank central axis (12) which is perpendicular to the tank bottom (4), wherein the two separate evaporation water outlets (10, 11) are spaced apart from one another in a transverse direction (13) oriented transversely with respect to the tank central axis (12).

4. The evaporation water tank (1) according to any of the preceding claims, characterized in that
the evaporation water tank (1) has a tank central axis (12) which is perpendicular to the tank bottom (4), wherein at least one tank side wall (5, 6) of these tank side walls (5, 6) is arranged at an angle with respect to the tank central axis (12), or
the evaporation water tank (1) has a tank central axis (12) which is perpendicular to the tank bottom (4), wherein at least two tank side walls (5, 6) of these tank side walls (5, 6) are opposite with respect to the tank central axis (12) in a transverse direction (13) oriented transversely, particularly at a right angle, as relates to the tank central axis (12), each spanning a tank side wall angle (a) between itself and the tank central axis (12) in the range from greater than or equal to 5° to less than or equal to 15°.

5. The evaporation water tank (1) according to any of the preceding claims, characterized in that
the evaporation water inlet (9) is arranged below an expected evaporation water level (15) on a single tank side wall (5, 6) of these tank side walls (5, 6).

6. The evaporation water tank (1) according to any of the preceding claims, characterized in that
the evaporation water tank (1) has a ventilation opening (16), through which tank air (34) from the evaporation water tank (1) can pass, for venting the evaporation water tank (1).

7. The evaporation water tank (1) according to claim 6, characterized in that
the ventilation opening (16) is covered by a membrane (17) through which tank air (34) from the evaporation water tank (1) can pass.

8. The evaporation water tank (1) according to any of the preceding claims, characterized in that
the tank side walls (5, 6) each have a large inner tank surface (18, 19) oriented toward the collection volume (3) that is covered or at least can be covered with evaporation water (33) and tank air (34), wherein a biocidal and/or algae-growth-inhibiting and/or antibacte-rial coating (20) is arranged on at least one of these large inner tank surfaces (18, 19).

9. The evaporation water tank (1) according to claim 8, characterized in that
a respective coating (20) covers at least 20% of the respective large inner tank surfaces (18, 19), and/or
a respective coating (20) covers a maximum of 90% or 95% of the respective large inner tank surfaces (18, 19), or
a respective coating (20) covers the respective large inner tank surface (18, 19) over the entire surface.

10. The evaporation water tank (1) according to any of the preceding claims, characterized in that
at least one tank side wall (5, 6) of these tank side walls (5, 6) has a biocidal and/or algae-growth-inhibiting and/or antibacterial substance which interacts with the evaporation water (33) collected in the evaporation water tank (1).

11. The evaporation water tank (1) according to claim 10, characterized in that
the biocidal and/or algae-growth-inhibiting and/or antibacterial substance is zinc pyrite.

12. The evaporation water tank (1) according to any of the preceding claims, characterized in that
the evaporation water tank (1) has a compressed air inlet (21) for compressed air to flow into the evaporation water tank (1).

13. The evaporation water tank (1) according to any of the preceding claims, characterized in that
the evaporation water tank (1) has a measuring tap (22) for arranging a sensor (23).

14. A use of an evaporation water tank (1) according to any of the preceding claims in a fuel cell device (2), particularly a fuel cell device (2) for a motor vehicle.

15. The use of an evaporation water tank (1) according to claim 14, characterized in that
the fuel cell device (2) has a fuel cell (24), a supply air path (25) leading to the fuel cell (24) for a cathode supply air flow (26) of water-containing supply air supplied to the fuel cell (24), and an exhaust air path (27) leading away from the fuel cell (24) for a cathode exhaust air flow (28) of water-containing exhaust air flowing out of the fuel cell (24),
wherein the supply air path (25) and the exhaust air path (27) are routed through a humidifier (29) of the fuel cell device (2), which humidifier communicates fluidically with the supply air and the exhaust air for humidifying the supply air and dehumidifying the exhaust air,
wherein the exhaust air path (27) is routed through a water separator (30) of the fuel cell device (2), which water separator communicates fluidically with the exhaust air for removing water from the exhaust air and for providing this water as evaporation water (33),
with a heat exchanger (31) for cooling the fuel cell (24), which has an evaporative cooler (32) for cooling the heat exchanger (31),
wherein the evaporative cooler (32) is assigned to the water separator (30), in a manner in which there is fluidic communication, and is supplied with evaporation water (33) by same,
wherein the evaporation water tank (1) is fluidically connected between the evaporative cooler (32) and the water separator (30).
